(19) United States
(12) Patent Application Publication
(10) Pub. No.: US 2025/0363353 A1
(43) Pub. Date: Nov. 27, 2025

(54) ARTIFICIAL INTELLIGENCE DEVICE FOR SKIPPY SIMULTANEOUS SELF-SPECULATIVE DECODING AND METHOD THEREOF

(71) Applicant: LG ELECTRONICS INC., Seoul (KR)

(72) Inventors: Wei ZHONG, Kitchener (CA); Touqir SAJED, Ottawa (CA); Manasa BHARADWAJ, Toronto (CA); Nikhil VERMA, Toronto (CA)

(73) Assignee: LG ELECTRONICS INC., Seoul (KR)

(21) Appl. No.: 19/219,844

(22) Filed: May 27, 2025

Related U.S. Application Data
(60) Provisional application No. 63/651,461, filed on May 24, 2024.

(51) Int. Cl. G06N 3/08; G06N 3/045

(52) U.S. Cl. CPC G06N 3/08; G06N 3/045

(57) ABSTRACT

A method for controlling an artificial intelligence (AI) device can include receiving, by a processor in the AI device, an input sequence of tokens, appending one or more mask tokens to the input sequence of tokens to generate a modified input token sequence, and inputting the modified input token sequence to a draft AI model, the draft AI model including a subset of layers of a target AI model. Further, the method can include generating, by the draft AI model, one or more draft tokens based on the modified input token sequence, verifying the one or more draft tokens, by the target AI model, to generate at least one accepted token, and generating an updated sequence of tokens by appending the at least one accepted token to the input sequence of tokens and outputting the updated sequence of tokens.

### CROSS-REFERENCE TO RELATED APPLICATIONS

This non-provisional application claims priority under 35 U.S.C. § 119 (e) to U.S. Provisional Application No. 63/651,461, filed on May 24, 2024, the entirety of which is hereby expressly incorporated by reference into the present application.

### BACKGROUND

### Field

The present disclosure relates to a device and method for artificial intelligence (AI) model acceleration. Particularly, the method can perform skippy simultaneous self-speculative decoding (S3D), which can provide high speedups during inference time and improved efficiency while maintaining accuracy and quality.

### Discussion of the Related Art

Artificial intelligence (AI) continues to transform various aspects of society and help users by powering advancements in various fields, particularly with regards to interactive applications, such as large language models (LLMs), chat-bots, and knowledge base question answering (KBQA) systems.

Large language models (LLMs) often play an important role in human-computer interaction. For example, large language models (LLMs) can help perform a wide range of natural language processing tasks, such as text generation, translation, summarization, code generation, and question answering.

However, existing approaches to generative AI models suffer from several limitations. For example, existing LLMs often rely on complex and computationally expensive systems, which use autoregressive techniques.

For example, a significant challenge associated with these models is the inherent latency in their inference process. Generating sequences of tokens typically requires sequential, iterative computations, where each new token is generated based on all of the previously generated tokens. This autoregressive decoding process can lead to substantial computational overhead and extended processing times, which is particularly problematic for applications requiring real-time responses or deployment on devices with limited computational resources.

Various strategies have been explored to accelerate the inference speed of these large models. One approach involves model compression techniques (e.g., different quantization techniques, pruning, etc.). These methods aim to reduce the model's size or computational complexity, but often require substantial modifications to the model architecture or require expensive additional training. Also, such model compression techniques may not always preserve the output fidelity of the original, uncompressed model.

Another strategy to improve inference latency involves speculative decoding, in which a separate, smaller AI model is used to predict a sequence of candidate output tokens. These candidate tokens are then subsequently validated by the primary, more computationally intensive language model. While such methods can offer speed improvements, they introduce their own set of challenges. For instance, effectively generating high-quality candidate tokens that align with the primary model's output characteristics, without incurring significant additional memory overhead or complex system integration, remains a hurdle. Also, using an additional smaller AI model to complement the primary AI model uses a significant amount of resources, in order to implement two separate models.

Further, difficulties can arise in efficiently producing useful draft outputs, particularly when the primary model itself has undergone extensive specialization or retraining. Also, the introduction of auxiliary components or modifications to the primary model can increase memory demands and system complexity. The overall efficacy of these speculative approaches can be diminished if the candidate tokens are frequently rejected, which can largely negate any potential speed gains.

Thus, existing generative AI approaches face various challenges related to complexity, efficiency, speed and quality.

Accordingly, there exists a need for improved methods that can accelerate inference in large language models while minimizing computational and memory overhead, avoiding extensive model retraining or modification, and maintaining high output quality, especially in resource-constrained environments.

Further, a need exists for a method that can provide a cost-effective, memory efficient, self-speculative decoding approach which can provide faster inference speed compared to existing models, while using a similar amount of memory usage or less memory usage.

Also, a need exists for a method that can achieve improved performance-memory ratios while requiring minimal architecture changes and less training data.

### SUMMARY OF THE DISCLOSURE

The present disclosure has been made in view of the above problems and it is an object of the present disclosure to provide a device and method that can provide improved model acceleration, in the field of artificial intelligence (AI). Further, the method can perform skippy simultaneous self-speculative decoding (S3D) to provide high speedups during inference time and improved efficiency while maintaining accuracy and quality.

An object of the present disclosure is to provide an artificial intelligence (AI) device and method that can accelerate inference while minimizing additional computational and memory overhead by defining a draft processing pathway within a target model itself by utilizing a selected subset of the target model's existing processing layers, such as specific lower and upper layers, while bypassing other middle layers during a draft generation phase. This draft pathway (e.g., draft model) whose selected layers can be efficiently fine-tuned for optimal performance, can be used to concurrently generate a plurality of candidate future tokens, potentially forming a tree of candidate sequences facilitated by the strategic use of mask tokens. These multiple candidate tokens can then be efficiently verified in parallel by the full target model. This skippy, self-speculative approach with selective layer utilization can significantly reduce latency and memory requirements compared to full autoregressive decoding or methods requiring separate draft models, while preserving the output quality and distribution of the original target model, thereby enabling the deployment on resource-constrained devices and enhancing the efficiency.

Also, since the AI device and method can utilize skippy simultaneous self-speculative decoding (S3D), the overall AI model can be referred to as S3D or an S3D model for case of understanding, but embodiments are not limited to.

Another object of the present disclosure is to provide a method for controlling an artificial intelligence (AI) device that can include receiving, by a processor in the AI device, an input sequence of tokens, appending one or more mask tokens to the input sequence of tokens to generate a modified input token sequence, inputting the modified input token sequence to a draft AI model, the draft AI model including a subset of layers of a target AI model, generating one or more draft tokens based on the modified input token sequence, verifying the one or more draft tokens, by the target AI model, to generate at least one accepted token, and generating an updated sequence of tokens by appending the at least one accepted token to the input sequence of tokens and outputting the updated sequence of tokens.

It is another object of the present disclosure to provide a method, in which the target AI model includes a decoder-based transformer, and the draft AI model includes at least a lowermost layer of the decoder-based transformer in the target AI model and an uppermost layer of the decoder-based transformer in the target AI model, and the draft AI model excludes one or more middle layers of decoder-based transformer in the target AI model.

Yet another object of the present disclosure is to provide a method that further includes fine-tuning the subset of layers of the target AI model that form the draft AI model, in which the fine-tuning is performed while parameters of the one or more middle layers of the decoder-based transformer excluded from the draft AI model remain frozen.

An object of the present disclosure is to provide a method, in which the generating the one or more draft tokens includes concurrently generating a plurality of candidate draft tokens for one or more token positions corresponding to the one or more mask tokens.

Another object of the present disclosure is to provide a method, in which the appending one or more mask tokens includes appending a plurality of mask tokens, and the generating the plurality of candidate draft tokens further includes generating a first set of candidate tokens for a first mask token position of the plurality of mask tokens, generating a second set of candidate tokens for a second mask token position of the plurality of mask tokens, and forming a tree structure of candidate draft sequences by combinatorially combining candidate tokens from the first set with candidate tokens from the second set, wherein the plurality of candidate draft tokens include tokens from the tree structure.

An object of the present disclosure is to provide a method, in which the verifying the one or more draft tokens includes verifying the tree structure of the candidate draft sequences using the target AI model in a single forward pass based on a tree attention mechanism.

Yet another object of the present disclosure is to provide a method, in which the verifying the one or more draft tokens includes determining a first probability for a draft token generated by the draft AI model, determining a second probability for the draft token from the target AI model, and accepting the draft token based at least in part on a comparison of the first probability and the second probability or dividing the second probability by the first probability.

An object of the present disclosure is to provide a method that includes in response to a determination during the verifying the one or more draft tokens resulting in at least one draft token being rejected, generating a replacement token for the at least one draft token being rejected using the target AI model operating in a full autoregressive mode.

Another object of the present disclosure is to provide a method, in which the draft AI model consists exclusively of the subset of layers of the target AI model without requiring additional trainable parameters separate from the target AI model for its operation.

An object of the present disclosure is to provide a method, in which the updated sequence of tokens maintains a generative distribution substantially identical to an output sequence that would be generated by the target AI model operating in a purely autoregressive mode without intervention from the draft AI model.

Another object of the present disclosure is to provide an artificial intelligence (AI) device including a memory configured to store a target AI model, and a controller configured to receive an input sequence of tokens, append one or more mask tokens to the input sequence of tokens to generate a modified input token sequence, input the modified input token sequence to a draft AI model, the draft AI model including a subset of layers of the target AI model, generate one or more draft tokens based on the modified input token sequence, verify the one or more draft tokens, by the target AI model, to generate at least one accepted token, and generate an updated sequence of tokens by appending the at least one accepted token to the input sequence of tokens and output the updated sequence of tokens.

Yet another object of the present disclosure is to provide a non-transitory computer readable medium storing computer-executable instructions that when executed by a processor, cause the processor to perform the operations of receiving an input sequence of tokens, appending one or more mask tokens to the input sequence of tokens to generate a modified input token sequence, inputting the modified input token sequence to a draft AI model, the draft AI model including a subset of layers of a target AI model, generating, by the draft AI model, one or more draft tokens based on the modified input token sequence, verifying the one or more draft tokens, by the target AI model, to generate at least one accepted token, and generating an updated sequence of tokens by appending the at least one accepted token to the input sequence of tokens and outputting the updated sequence of tokens.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an overview example of an AI device configured with simultaneous self-speculative decoding (S3D) while implementing a pass through a target model according to an embodiment of the present disclosure.

FIG. 5 illustrates an overview example of an AI device configured with S3D implementing a pass through a draft model with verification by a target model according to an embodiment of the present disclosure.

FIG. 6 illustrates example of a transformer portion with an encoder and decoder included in an S3D model according to an embodiment of the present disclosure.

FIG. 7 illustrates an example flow chart for a method of controlling an AI device configured with S3D to perform inference acceleration according to an embodiment of the present disclosure.

FIG. 8 illustrates an overview of the architecture of the pipeline for a S3D AI model, according to an embodiment of the present disclosure.

FIG. 9 illustrates evaluation results showing a speed comparison between S3D and related art methods, according to an embodiment of the present disclosure.

FIG. 10 illustrates evaluation results showing training efficiency comparisons between S3D and related art methods, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

For simplicity of explanation, a situation of accelerating a large language model is used an example, but embodiments are not limited thereto. For example, the S3D model acceleration techniques disclosed herein can be applied to other types of AI models, such a text-to-image generation, image-to-text generation, text-to-video generation, language translation, object identification and robot model control, and self-driving AI models, etc. Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

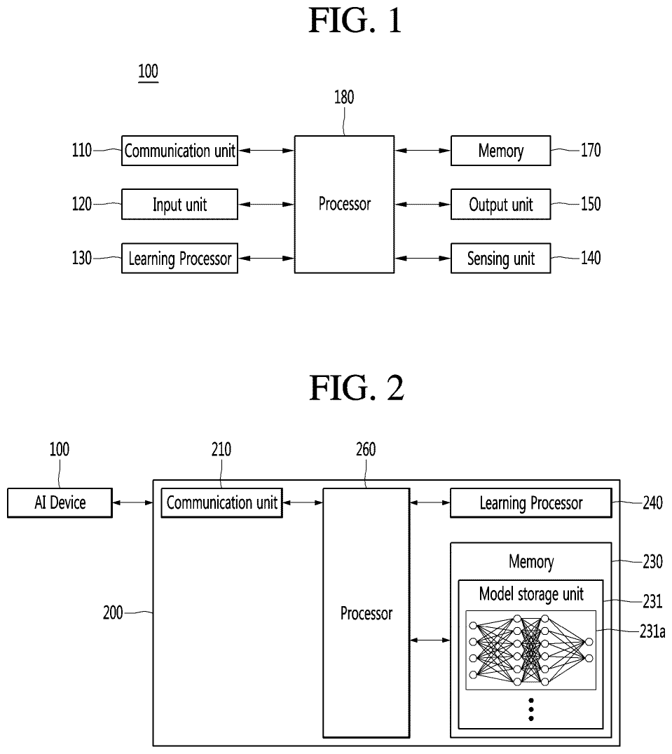

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

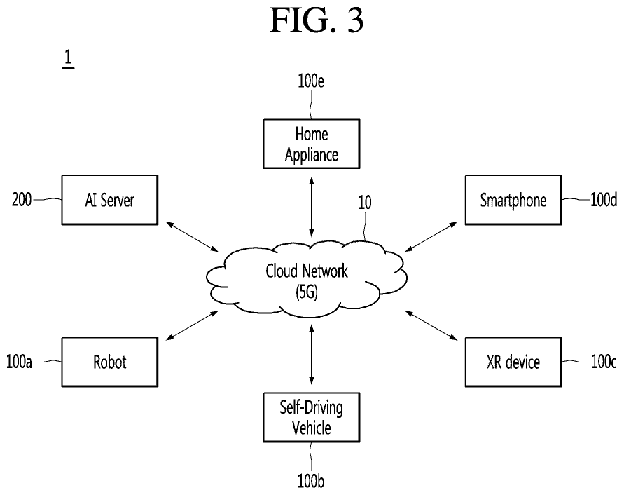

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement a skippy simultaneous self-speculative decoding (S3D) AI mode to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and can determine an emotional state of the user and produce an answer to a query, carry out an action or movement, animate a displayed avatar or a recommend an item or action based on the determined emotional state.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system I can be connected to each other through the cloud network 10. In particular, each of the devices 100a to 100c and 200 can communicate with each other through a base station, but can directly communicate with each other without using a base station.

The AI server 200 can include a server that performs AI processing and a server that performs operations on big data. According to embodiments, the skippy simultaneous self-speculative decoding (S3D) AI model can be fully implemented on an edge device (e.g., locally on devices 100a to 100e) or fully implemented AI server 200 in which an edge device collected the raw audio and video signals to provide to the AI server 200. According to another embodiment, parts of the S3D AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

In addition, the AI server 200 can learn the artificial neural network according to the machine learning algorithm instead of the AI devices 100a to 100e, and can directly store the learning model or transmit the AI model to the AI devices 100a to 100c.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of as a large language model (LLM), a chat-bot, a digital avatar assistant, a question and answering system or a recommendation system, etc. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state.

According to an embodiment, the AI device 100 can provide skippy simultaneous self-speculative decoding (S3D) to high speedups during inference time and improved efficiency while maintaining accuracy and quality.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

According to an embodiment, the AI device 100 can accelerate inference while minimizing additional computational and memory overhead by defining a draft processing pathway within a target model itself by utilizing a selected subset of the target model's existing processing layers, such as specific lower and upper layers, while bypassing other middle layers during a draft generation phase. This draft pathway (e.g., draft model) whose selected layers can be efficiently fine-tuned for optimal performance, can be used to concurrently generate a plurality of candidate future tokens, potentially forming a tree of candidate sequences facilitated by the strategic use of mask tokens. These multiple candidate tokens can then be efficiently verified in parallel by the full target model. This skippy, self-speculative approach with selective layer utilization can significantly reduce latency and memory requirements compared to full autoregressive decoding or methods requiring separate draft models, while preserving the output quality and distribution of the original target model, thereby enabling the deployment on resource-constrained devices and enhancing the efficiency.

As discussed above, generative AI technology faces several challenges. Many existing models are complex and computationally expensive, hindering real-time use and deployment on devices with limited resources. Also, some systems rely on distributed model architecture and transmitting data to remote servers can raise privacy concerns. These issues highlight the need for a method that can provide a cost-effective, memory efficient, self-speculative decoding approach which can provide faster inference speed compared to existing models, while using a similar amount of memory usage or less memory usage.

For example, Large Language Models (LLMs) are used in a wide array of text-based generative artificial intelligence applications. These models are configured to generate natural language responses which can enable functionalities such as answering user queries, engaging in conversational interactions, and supporting various automated tasks that involve language understanding and generation.

The operational capabilities of many such advanced language models often derive from architectures that employ attention mechanisms. These attention mechanisms empower the models to comprehensively analyze and integrate contextual information from input sequences. By enabling each element in a sequence to relate to and weigh the importance of other elements, these models can effectively discern complex relationships and dependencies within the text. This thorough contextual analysis contributes significantly to the high levels of reasoning and performance these models exhibit across a multitude of natural language processing tasks.

Despite their notable performance, a characteristic of these attention mechanisms is a computational complexity that scales significantly with the length of the input sequence. For instance, the computational load associated with processing attention can increase quadratically with the number of tokens in an input sequence (e.g., for N tokens (roughly words), N² computations may be needed). Thus, as the length of the textual input or the conversational context grows, the computational resources and time required to generate a response can increase substantially. In models employing multiple such attention components (e.g., multiple attention heads), this computational burden can be further compounded, posing challenges for latency-sensitive applications and resource-constrained environments.

According to an embodiment, the AI device 100 implementing the S3D model can include a target model (e.g., full LLM model) and a draft model aspect, in which the draft model can include only some portions of the target model.

In other words, according to an embodiment, the draft model does not need to be completely separate and distinct instance from the target model, rather the draft model can refer to using only some layers of the full target model while skipping other layers. For example, when executing a drafting process to generate predicted tokens, a different path through the target model can be followed in which lower layers and upper layers are utilized, while middle layers can be skipped. For case of explanation, this different path through the target model can be referred to as a draft model.

For example, as a brief overview, disclosed herein are systems and methods for enhancing the inference efficiency of an AI model (e.g., an LLM). In embodiments, an approach is provided where selected layers within a target or original LLM are subjected to a fine-tuning process. This targeted fine-tuning is configured to optimize prediction accuracy when the LLM operates in a self-speculative decoding mode (e.g., draft model mode), which utilizes only some designated draft layers from the same original LLM to generate candidate token sequences.

For example, while skipping middle layers, one or more lower layers of the LLM and one or more upper layers can be used to draft tokens (e.g., make guesses) which can then be verified and either accepted or rejected for creating the output sequence.

In other words, during the inference phase, the described approach can facilitate the generation of text by performing draft token generation and subsequent verification concurrently. Multiple candidate tokens can be drafted simultaneously using the draft layers of the original LLM. These drafted tokens can then be efficiently verified in parallel by using all the layers of the original LLM, including the selectively fine-tuned layers. This concurrent drafting and verification process is designed to achieve high throughput in text generation while concurrently reducing overall memory consumption, as it obviates the need for a distinct, separate draft model.

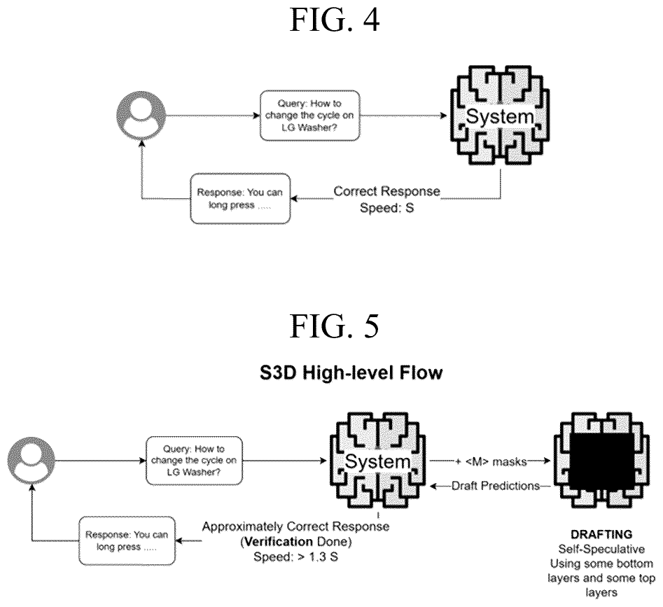

For example, according to an embodiment, FIG. 4 shows an example of processing a user query (e.g., “How to change the cycle on LG Washer?”) using the full target model in an autoregressive manner, in which a correct response (e.g., “You can long press . . . ”) is generated with speed “S.” In other words, all layers of the full target model are used to iteratively generate the correct response in an autoregressive manner which takes speed “S.” In this example, the full target model is represented by the entire brain (e.g., System).

Also, according to an embodiment, FIG. 5 shows an overview example of processing the user query using a skippy simultaneous self-speculative decoding (S3D) method, in which the correct response is generated with a speed greater than or equal to 1.3 S. In this situation, many of the tokens included in the correct response were generated by the draft model using masks and draft predictions and utilizing lower and upper layers of the target model while skipping middle layers, which can be viewed as following a different path through the full target, and then sending the draft predictions to the full target model for parallel verification. For example, in FIG. 5, the draft model is represented by the brain image with the middle portion blocked out in black, while the full target model is represented by the unblocked brain image labeled “System.” The S3D method will be discussed in more detail at later sections detail below.

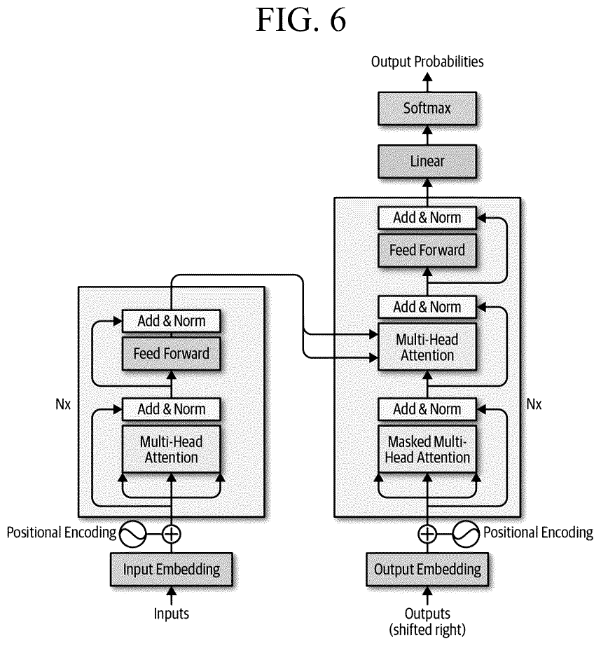

Further, with reference to FIG. 6, the target model (e.g., full LLM model, or the full brain system from FIGS. 4 and 5) can be based on a transformer architecture that includes an encoder (e.g. left side of FIG. 6) and a decoder (e.g. right side of FIG. 6), which can operate in an autoregressive manner. FIG. 6 shows a non-limiting example of a target model that includes a transformer having an encoder-decoder architecture, but embodiments are not limited thereto. For example, according to a preferred embodiment, the S3D method can be applied to a decoder-only transformer model (e.g., right side of FIG. 6).

For example, the transformer is designed to handle sequences of input data (e.g., sentences or paragraphs), by first converting the input tokens into numerical representations known as embeddings. Tokens can be words or sub-parts of words or characters. These embeddings are then augmented with positional information which allows the model to understand the order of tokens within the sequence.

For example, the core of the transformer can include a stack of Nx layers (e.g., or processing blocks), where Nx is greater than or equal to 1, which iteratively refine these representations to capture complex relationships and contextual nuances.

Each transformer layer can include a self-attention mechanism. This mechanism can enable the model to, for each token in a sequence, dynamically weigh the importance of all other tokens in that same sequence (or a relevant portion thereof) when computing an updated representation for the current token. This allows the model to capture long-range dependencies and understand how different parts of the input text relate to one another, effectively building a rich contextual understanding. In addition to self-attention, each transformer layer can include a position-wise feed-forward network that further process each token's representation independently.

For example, given an input token sequence such as “The quick brown fox jumps over.” Upon receiving this input, the transformer can tokenize it, convert the tokens to vector embeddings, and add positional encodings. As this sequence passes through the successive transformer layers (e.g., Nx layers), the self-attention mechanisms can help analyze the relationships between words like “quick,” “brown,” and “fox,” and their relationship to the verb “jumps” and the preposition “over,” as well as the initial article “The.”

Through this processing, the model learns to understand the semantic and syntactic structure of the input. The model can be configured or trained for a sequence manipulation task and then generates an output sequence such as “quick brown fox jumps over the.” This output demonstrates the model's ability to not only understand the input components but also to rearrange and append tokens based on the learned patterns and the specific objective it is trained to achieve.

The generation of the output sequence (e.g., the prediction of subsequent text) can involve a final output layer. The final layer can take the processed representations from the last transformer layer (e.g., among the Nx layers) and converts them into a probability distribution over a predefined vocabulary of possible tokens. In an autoregressive generation process, tokens are generated one at a time, with each newly generated token being influenced by the original input and the tokens generated thus far in the output sequence.

In more detail, as shown in FIG. 6, the encoder can include a plurality of identical layers. For example, a stack of 6 layers can be used, but embodiments are not limited thereto and more than 6 layers can be implemented. Each transformer layer within this stack can include two sub-layers. The first sub-layer incorporates a multi-head self-attention mechanism configured to weigh the significance of different portions of an input sequence. The second sub-layer can include a position-wise, fully connected feed-forward network, which applies a non-linear transformation independently to each position in the sequence.

In addition, to enhance gradient flow during training and improve model performance, a residual connection can be employed around each of these two sub-layers and layer normalization can be performed (e.g., add & normalize). For example, the output of each sub-layer can be characterized as the result of layer normalization applied to the sum of the input to the sub-layer (x) and the output of the function implemented by the sub-layer itself (Sublayer(x)).

According to an embodiment, the decoder component of the transformer can also be structured as a sequential stack of a plurality of identical layers (e.g., Nx=6 or more layers). Each layer within the decoder can include three sub-layers (e.g., first sub-layer, a second sub-layer, and a third sub-layer). For example, similar to the encoder, the decoder can include a multi-head self-attention mechanism and a position-wise fully connected feed-forward network, except here the first multi-head self-attention mechanism is a masked multi-head self-attention mechanism.

Also, distinct from the encoder layers, each decoder layer further includes an additional sub-layer. This additional sub-layer is configured to perform multi-head attention over the output representations generated by the encoder. This mechanism allows the decoder to focus on relevant parts of the input sequence, as processed by the encoder, when generating an output sequence. Also, residual connections are employed around each of the sub-layers within the decoder, and each such connection is followed by layer normalization to promote stable and effective training (e.g., add & normalize).

In addition, the self-attention sub-layer within the decoder stack is modified to enforce causality in the generation process (e.g., masked attention). This modification is referred to as masking which prevents any given position in the decoder from attending to subsequent positions during the computation of its own representation. This masking combined with an offsetting of output embeddings by one position (e.g., shifted right) during training or inference can ensure that the prediction for any given position i in an output sequence can only depend on the known outputs at positions preceding i. For example, this mechanism facilitates autoregressive generation, where tokens are produced sequentially.

However, the autoregressive nature of a full transformer-based Large Language Model (LLM) presents substantial challenges and drawbacks. For example, a full transformer based LLM generates text autoregressively, meaning the model iteratively creates responses one word or token at a time, where each new token depends on the ones generated before it.

This step-by-step process is inherently slow because the model cannot predict the next token until the current one is fully processed, which uses a complete run through the entire complex model for every single token. This sequential approach also consumes significant computational resources and memory. The large size of these models means numerous calculations are performed for each token, and the need to consider all previously generated tokens to inform the next one means that the amount of information to be processed and stored in memory (such as in a key-value cache) continuously grows with the length of the text, making the process inefficient, particularly for longer responses or on devices with limited capacity.

Also, not all tokens are equal. For example, some tokens may be easier to predict than others and might not require all of the computational resources of the full LLM model in order to accurately predict the next word. For example, given the input sequence “The quick brown fox jumps over” it may be relatively easy to predict that the next token in the sequence should be “the” (e.g., The quick brown fox jumps over the”).

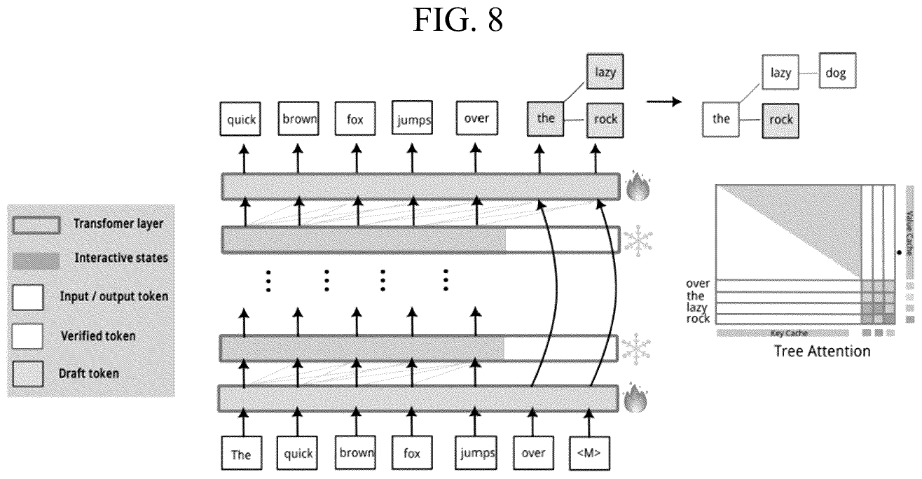

For explanation, FIG. 6 shows a non-limiting example that includes an encoder-decoder architecture for a target model, but embodiments are not limited thereto. For example, according to a preferred embodiment, the S3D method can be applied to a decoder-only transformer model (e.g., right side of FIG. 6). Also, an example pipeline for a decoder-only model is shown in FIG. 8, which is discussed in more detail below.

According to an embodiment, the S3D AI model employs a draft model to try and accurately guess what the next token should be, whenever possible. The draft model can be select parts of the full target model (e.g., selected lower and upper layers, while skipping over middle layers). Also, the guesses made by draft model can then be verified and either accepted or rejected by the full target model, in which case, verification of a predicted token by the target model can occur much faster than regressively generating that next token itself. In addition, when multiple mask tokens are used, then multiple draft predictions can be generated at the same time, and these multiple draft predictions can be verified in parallel by the full target model, which can further improve efficiency. Also, if a predicted token generated by the draft model gets rejected, then the full target model can perform a full model run to generate the correct next token.

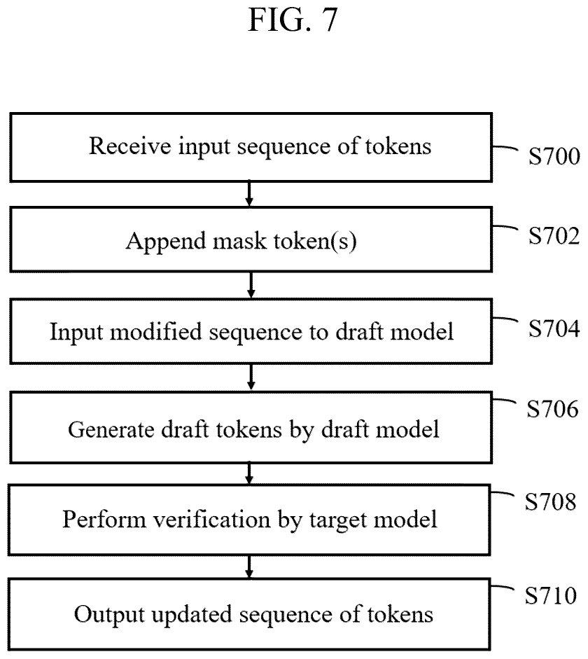

FIG. 7 shows an example flow chart of a method according to an embodiment of the present disclosure. For example, according to an embodiment, a method for controlling an AI device can include receiving, by a processor in the AI device, an input sequence of tokens (e.g., S700), appending one or more mask tokens to the input sequence of tokens to generate a modified input token sequence (e.g., S702), inputting the modified input token sequence to a draft AI model, the draft AI model including a subset of layers of a target AI model (e.g., S704), generating, by the draft AI model, one or more draft tokens based on the modified input token sequence (e.g., S706), verifying the one or more draft tokens, by the target AI model, to generate at least one accepted token (e.g., S708), and generating an updated sequence of tokens by appending the at least one accepted token to the input sequence of tokens and outputting the updated sequence of tokens (e.g., S710).

In more detail, according to an embodiment, a method is disclosed for accelerating inference by a target Large Language Model (LLM). This method can be implemented by an Artificial Intelligence (AI) device equipped with a processor and memory, in which the memory stores the target LLM which includes a plurality of layers arranged sequentially.

The method can include designating specific layers within the target LLM to serve distinct roles during a self-speculative decoding process. A first subset of the plurality of layers of the target LLM can be designated as draft layers. These draft layers can include at least one lower layer and at least one upper layer from the sequential arrangement of layers within the target LLM. Also, a second subset of the plurality of layers can be designated as skipped layers during the draft generation process. This second subset includes at least one middle layer of the target LLM, which is positioned organizationally between the aforementioned at least one lower draft layer and at least one upper draft layer.

Also, at least a portion of these designated draft layers of the target LLM can undergo a fine-tuning process. This fine-tuning can optimize the capability of these draft layers to generate high-quality candidate tokens when utilized in the self-speculative decoding mode. An aspect of this fine-tuning stage is that the parameters of the designated skipped layers (e.g., the second subset of layers) remain frozen or substantially unchanged, thereby preserving the integrity of those parts of the original target LLM not actively used for drafting.

The operational phase of the method can begin when the AI device receives an input prompt, which includes an existing sequence of tokens. The processor of the AI device then appends at least one special mask token to this input prompt. This modified input prompt, now including the mask token(s), can serve as a basis for the draft generation stage.

Following the appending of mask token(s), the method can proceed to generate a plurality of candidate draft tokens. This generation can be performed using the previously fine-tuned draft layers of the target LLM. Also, during this draft generation phase, the designated skipped layers (e.g., the second subset of layers) are bypassed or otherwise not utilized for computation. The candidate draft tokens can be generated concurrently for one or more token positions. These positions correspond to those of the appended mask token(s) and can optionally include the token position in the input prompt that immediately precedes the first appended mask token. This concurrent generation allows for the exploration of multiple potential continuations of the sequence simultaneously.

Once the plurality of candidate draft tokens have been generated, a verification process can be initiated. This verification stage can utilize the full target LLM, meaning it engages the entirety of its plurality of layers, including both the draft layers (which were used for draft generation) and the skipped layers (which were bypassed during draft generation). The purpose of this verification is to assess the candidate draft tokens and determine one or more acceptable candidate draft tokens from the generated plurality of draft tokens.

Finally, an output sequence can be formed based on the outcome of the verification process. The one or more candidate draft tokens that were determined to be acceptable can be incorporated into the output sequence, effectively extending the original input prompt. In instances where the verification process determines that no candidate draft token among the generated plurality is acceptable for a given token position, then the method can provide a fallback mechanism, in which a token for that specific position is then generated using a standard operational mode of the full target LLM, ensuring sequence completion.

FIG. 8 illustrates an overview of the architecture of the pipeline for a S3D AI model, according to an embodiment of the present disclosure.

For example, according to embodiments, the S3D AI model, can provide for highly efficient fine-tuning or training procedures specifically adapted for enabling or enhancing self-speculative decoding operations. This efficient training can allow for rapid adaptation of a Large Language Model (LLM) for improved inference performance.

For example, in FIG. 8, the long rectangular bars with the fire icon at the right side can represent the layers (e.g., among Nx) in the decoder of the transformer in the LLM that are selected for use as the draft model and these layers can be fine-tuned, while the long rectangular bars with the snowflake icon can represent the layers in the target LLM that are skipped over by the draft model (e.g., middle layers) in which the parameters of these skipped middle layers are frozen and do not get fine turning. Since only some lower layers and upper layers receive fine tuning, the integrity of the target model can largely be persevered and fine tuning can be efficiently carried out.

Also, the fine-tuning process for the S3D AI model can involve modifying only a selected subset of layers within the original LLM (e.g., target model), which are designated to function as draft layers for the self-speculative decoding process. For example, such a selection can include fine-tuning specific lower and upper layers of the original LLM to serve as draft layers, while intermediate or middle layers of the original LLM (e.g., target model) can be substantially unchanged or skipped during this targeted fine-tuning. The particular number and configuration of layers chosen to function as draft layers can be adjusted or optimized to manage a trade-off between the accuracy of the generated draft tokens and the achievable inference speed-up. For example, utilizing a greater number of layers for drafting can enhance draft accuracy at the cost of some potential speed gains, whereas using fewer layers can increase speed-up while potentially reducing initial draft accuracy.

Another aspect of the S3D AI model is that it does not necessitate the introduction of new architectural parameters into the system, rather a sub-set of existing layers are utilized e.g., due to its self-speculative decoding. This contrasts with other existing approaches that might require additional decoding heads or entirely separate draft models which increases overall model complexity and parameter count.

In addition, due to the minimal number of parameters subject to fine-tuning in the S3D AI model, the training or adaptation process can be performed with substantially less training data compared to full fine-tuning or training of auxiliary models. This reduction in data requirements leads to high training efficiency and reduced computational overhead for model adaptation. For example, in some embodiments, the S3D AI model can be effectively fine-tuned using a comparatively small dataset, such as approximately ten thousand to twenty thousand rows of training data, in order to achieve desired performance characteristics for speculative decoding.

The preceding discussion has provided a general overview of certain aspects of the disclosed embodiments. The following sections will now describe the drafting and verification features in more detail, as implemented in various embodiments according to the present disclosure.

According to an embodiment, the S3D AI model can perform simultaneous drafting using the draft model. With reference to FIG. 8, during a draft generation stage, an embodiment of the S3D model can receive the current input prompt, which can include the text generated up to a certain point.

Further in this example, a special mask token, denoted for illustrative purposes as <M>, or a plurality of such mask tokens, is appended to the end of this current prompt. The introduction of such mask token(s) facilitates a simultaneous or parallel drafting process, enabling the model to concurrently generate candidate predictions for the token position immediately preceding the first mask token as well as for the position(s) occupied by the mask token(s) themselves. This parallel prediction capability is further illustrated in FIG. 8, where draft tokens are shown associated with the last word of the prompt and a subsequent mask token.

In processing these designated draft token positions (e.g., the positions corresponding to the appended mask token(s) and potentially the last token of the original prompt), a modified layer utilization strategy can be employed. For example, certain intermediate layers of the LLM architecture (e.g., of the target model) can be selectively skipped or bypassed only for computations related to these draft token positions. For example, the drafting process can include skipping the middle layers on top of or over the draft tokens so that the top layer(s) of the model architecture can still utilize and have access to the one-layer-lower features of the previous tokens verified by the complete target model. This can help ensure that even with layer skipping for speed, the draft generation remains conditioned on rich representations of the verified context.

According to an embodiment, the drafting process is scalable with respect to the number of simultaneously drafted tokens. While the example in FIG. 8 illustrates the use of a single mask token, thereby enabling simultaneous next-token prediction for two positions (e.g., the last token of the prompt and the position of the mask token), the drafting can be extended to multiple mask tokens (e.g., two or more <M>). By introducing a desired number “d−1” of mask tokens at the end of the prompt, the model can perform simultaneous drafting for “d” token positions. For instance, if five mask tokens (e.g., <M>) are added at the end of the prompt, the model can generate six predictions for the last word (e.g. “over” in FIG. 8) and the five mask <M> tokens.

According to an embodiment, subsequent to the generation of one or more speculative tokens, a verification process is employed to ascertain the correctness and contextual appropriateness of these predicted tokens as a continuation of the sequence generated thus far.

For example, the verification can be conducted utilizing the original Large Language Model (LLM) (e.g., target model), which assesses whether the speculative tokens form a meaningful and coherent extension. For instance, in a scenario where the prompt pertains to factual information, such as “The official languages of Canada are ______,” the verification process can determine whether the speculative completions (e.g., “English” or “French”) are factually and contextually valid, as opposed to alternatives that might be linguistically plausible but factually incorrect or contextually inappropriate (e.g., “Mandarin” or “Hindi” in this specific example).

Further, based on this verification assessment, speculative tokens that are determined to be appropriate and align closely with, or are consistent with, the predictions the original model would likely have made in a non-speculative, autoregressive step are accepted and incorporated into the output sequence. Conversely, speculative tokens identified as incorrect, contextually unsuitable, or significantly divergent from the original model's predictive distribution are rejected. If a predicted token generated by the draft model is rejected during the verification process, then a new, correct token be can generated by the full verification run through the original Large Language Model (LLM) (e.g., target model).

In more detail, according to an embodiment, given a transformer decoder-only model, hereinafter denoted as target model Mₚ. This target model Mₚ can be configured to generate a probability distribution for the next token, p(t≤₁), conditioned upon a sequence of preceding context tokens t≤ᵢ=(t1,t2, . . . , tᵢ). The generation of this distribution can be described in terms of sequential operations performed by the layers of the transformer model, based on Equations (1), (2), and (3), below.

$${h}_{i}^{( 0 )} = Emb ( {t}_{i} ) \qquad [ Equation 1 ]$$

$${h}_{i}^{( ℓ )} = {T}^{( ℓ )} ( {h}_{\leq i}^{( ℓ - 1 )} , {Pos}_{\leq i} ) \qquad [ Equation 2 ]$$

$${t}_{i + 1} \sim p ( {t}_{\leq i} ) = LM - Head ( {h}_{i}^{( L )} ) \qquad [ Equation 3 ]$$

In the above equations, Emb represents the embedding transformation, and T^{(l)} denotes the transformer layer at level l, which receives the context hidden states from the previous layer, associated with their position information Pos≤ᵢ. The LM-Head maps the hidden space to a vocabulary distribution p for the next token sampling. For example, the Language Model Head (LM-Head) can function to map this high-dimensional hidden state vector from the model's internal representation space to a probability distribution, p, over the entire vocabulary of possible tokens, which can provide the likelihoods for each potential token in the vocabulary to be the next token in the sequence, from which a selection can be made for sampling or generation.

In addition, The decoder-only language model can be trained using the next-token prediction task, where training involves employing cross entropy loss across tokens in parallel. Given a sample of sequential tokens tᵢ, i=1, 2, . . . , N, the loss can be defined by Equation (4) below.

$$ℒ = \frac{1}{N - 1} {{\sum }^{N - 1}}_{i = 1} - log {p ( {t}_{\leq i} )}_{{t}_{i + 1}} \qquad [ Equation 4 ]$$

Further in this example, skippy simultaneous self-speculative decoding (S3D) can be employed.

In the S3D model, the draft model M_{q} can use partial layers from target model Mₚ. For example, draft model M_{q} can use one or more lower layers of the decoder and one or more upper layers of the decoder while skipping middle layers.

Also, according to an embodiment, the middle layers to be skipped can be selected symmetrically from the upper half of the decoder and the lower half of the decoder. For example, if the decoder of the transformer includes six layers, then the middle 4 layers can be skipped, in which the draft model can use the first layer and the sixth layer, but embodiments are not limited thereto.

For example, according to another embodiment, the middle layers to be skipped can be selected asymmetrically from the upper half of the decoder and the lower half of the decoder. For example, if the decoder of the transformer includes six layers, then the third, fourth and fifth layers can be skipped, in which the draft model can use the first layer, the second layer and the sixth layer, but embodiments are not limited thereto and other selections and arrangements of skipped layers can be employed.

According to an embodiment, the draft model can use at least one lower layer and at least one upper layer, while skipping at least one middle layer of the decoder portion of the transformer.

In addition, by reusing portions of the transformer decoder architecture and circumventing the need for auxiliary modules, a Masked Language Modeling (MLM) task employed in transformer encoder training can be used for predicting tokens with the decoder draft model. This involves inserting a special mask token, denoted as <M>, into future inputs to predict the next y tokens concurrently, based on Equation 5 below.

$${t}_{i + 1} , … , {t}_{i + γ} \sim q ( {t}_{\leq i} , {\underbrace{< M > , … , < M >}}_{γ - 1} ) \qquad [ Equation 5 ]$$

Also, the draft model M_{q} uses all previous hidden states of the target model

$${h}_{\leq i , ℓ}^{( ℓ )} = 1 , 2 , … , L ,$$

based on Equation 6 below.

$${h}_{i}^{( ℓ )} = {T}^{( ℓ )} ( {h}_{\leq i}^{( ℓ - 1 )} , {Pos}_{\leq i} ) \qquad [ Equation 6 ]$$

Also, the simultaneously generated tokens at j=i+1, i+2, . . . , i+y require only propagating through lower and top layers of the decoder stack of the transformer, skipping middle m-th to n-th layers of the target model, based on Equations 7 and 8, below.

$${h}_{j}^{( n - 1 )} = {h}_{j}^{( m )} \qquad [ Equation 7 ]$$

$${h}_{j}^{( {ℓ}^{′} )} = {T}^{( {ℓ}^{′} )} ( {h}_{\leq j}^{( {ℓ}^{′} - 1 )} , {Pos}_{\leq j} ) \qquad [ Equation 8 ]$$

In the above equations, non-skipping layers [symbol] =1, 2, . . . , m, n, n+1, . . . , L. Also, a non-skipping layer [symbol] is able to utilize previous states of the target model, e.g.,

$${h}_{\leq i}^{( ℓ - 1 )} .$$

In addition, the current draft states from top layers are kept for decoding. Also, as discussed above, at least one or more of the lower layers of the decoder is not skipped.

Further in this example, after one or more draft tokens (e.g., predicted tokens) have been generated by the draft model, a verification process can be employed. The drafted tokens can be verified by comparing the probability for that token from the target model p(tᵢ₊ⱼ) with the probability for that token from the draft model q(tᵢ₊ⱼ), successively and accepting each draft token with a probability of min (1, p(tᵢ₊ⱼ)/q(tᵢ₊ⱼ)).

In other words, the guesses made by the draft model need to be checked (e.g., “verified”) by the target model to determine if the guesses are “good enough.” The target model can take a predicted token and determine that it would have guessed that same token with a probability p while the draft model has a confidence that the predicted token is correct according to a probability q.

Then the S3D model can divide the target model's chance p by the draft model's chance q (e.g., p/q). If the target model is even more sure that the predicted token is correct than the draft model was confident (e.g., p/q is a large number such as 2 or 3), then the predicted token can be verified and accepted (e.g., added to the output sequence). However, if the target model is less sure than the draft model (e.g., meaning p/q is a small number, such as 0.5), the S3D model still might keep predicted token, but with a probability equal to the p/q value (e.g., still a non-zero chance of keeping the predicted token, even if a small chance). For example, if p/q is 0.5, there is a 50% chance the S3D model keeps the predicted token. Further in this example, if p/q is greater than 1, the chance of keeping the predicted token is 100% (or 1, because cannot have a greater than 100% chance), if p/q is less than 1 (e.g., 0.5), then the chance of keeping the predicted token is that fraction (e.g., 0.5 or 50%).

Also, if the predicted token is rejected based on the p/q value, then the target model can execute a full run (verification) through all decoder layers to generate a correct token to replace the predicted token generated by the draft model. However, embodiments are not limited thereto. For example, according to another embodiment, a second or third draft model that uses even more lower layers and more upper layers than the first draft model while still skipping some middle layers can be employed as an intermediary prediction, or additional guess. For example, the S3D model can try performing one or more better guesses by a more enhanced draft model before finally turning to use of the full target model to generate a correct token replacement.

In this way, the final output sequence generated by the S3D model, which includes the draft and target portions, will be substantially the same or even identical as if all the tokens in the final output sequence were generated entirely by the full target model, but produced in much less time using less memory resources. For example, there may be slight differences between a final output sequence generated by the S3D model compared to final output sequence generated purely by the target model, but the output form by the S3D model would be good enough and substantially the same (e.g., may be some minor word choice differences based on the chance probabilities).

Also, while the example of a sequence-to-sequence AI model is discussed above when describing aspects of S3D, embodiments are not limited thereto. For example, according to embodiments, the S3D method, including a draft model and a target model, can be applied to other types of models, such as a vector-to-sequence model or a sequence-to-vector model, etc.

According to other embodiments, different selection creation can be used to determine whether to accept or reject the predicted token generated by the draft model, e.g., different predetermined criteria or conditions can be used for accretion/rejection. For example, according to an embodiment, the predicted token can be accepted if the difference between the probability q determined by the draft model and the target model's probability p is within a predetermined range or a predetermined threshold, e.g., within a 0.2 difference for example or within plus or minus 10%. Also, according to another embodiment, the predicted token can be accepted only when the probability q determined by the target model is greater than or equal the probability p determined by the draft model (e.g., when the target model is more sure or at least equally as sure as the target model about the predicted token).

In addition, according to an embodiment, upon completion, one more last token t_{i+γ+1} can be sampled from the target distribution p. On rejection, sampling can be done from a normalized distribution of max(0, p−q). In greedy decoding, this process can be equivalent to accepting only the matched tokens produced from p and q, but embodiments are not limited thereto. According to other embodiments, other sampling strategies can be used such as beam search, diverse sampling, temperature sampling or Top-k sampling.

According to an embodiment, the S3D model can be extended to include tree attention to verify multiple branches of predictions given top candidates of the k-th draft token. For example, tree attention can be used to generate more draft tokens from top-K token prediction candidates. In other words, by applying tree attention, rather than limiting the self-speculative decoding to generating one sequence of future tokens, tree attention can be applied for a tree of all possible continuations.

For example, tree attention can provide an attention mechanism within the model designed to efficiently process this entire tree of drafted tokens in a single forward pass. Instead of evaluating each path in the tree independently, tree attention can allow the model to consider all drafted branches simultaneously.

According to an embodiment, the generation of a diverse set of candidate token sequences for subsequent verification can be facilitated by the utilization of multiple mask tokens. For example, numerous candidate sequences can be generated by appending a plurality of mask tokens to the current input prompt. The S3D model can then be configured to predict potential token completions for each of these appended mask token positions, thereby enabling the construction of multiple distinct continuation sequences (e.g., see right side of FIG. 8).

For example, the introduction of two or more mask tokens can allow for a combinatorial expansion of possible draft sequences, effectively forming a tree structure of candidates. For instance, if two mask tokens are appended to the input prompt, the model can generate a set of high-probability candidate tokens for the first mask position and another set of high-probability candidate tokens for the second mask position. By way of non-limiting example, if the model considers the top “N” candidate tokens for the first mask position and the top “M” candidate tokens for the second mask position, a total of N*M distinct token draft sequences can be constructed by combining each of the “N” candidates for the first mask with each of the “M” candidates for the second mask.

This combinatorial generation process can result in a branched structure, or tree, of candidate sequences, where each path from the root (e.g., the original prompt) through the combinations of predicted mask tokens represents a unique draft sequence. For example, if for a first mask position, candidate tokens such as “lazy” and “rock” are generated, and for a second mask position, candidate tokens “dog” and “mat.” are generated, combined draft sequences such as (“lazy,” “dog”), (“lazy,” “mat”), (“rock,” “dog”), and (“rock,” “mat”) can form branches in the candidate tree.

Further in this example, this tree of numerous distinct draft sequences can be presented to the target model for verification, which can enhance the efficiency of the speculative decoding process. For example, the availability of a larger and more diverse set of candidate sequences increases the likelihood that at least one of these sequences, or a significant prefix thereof, will align with the target model's own predictions. This can lead to the acceptance of multiple tokens in a single verification step, potentially exceeding the number of mask tokens initially employed, thereby improving the overall throughput and reducing the latency of text generation.

According to an embodiment, training of the S3D model can have a training objective to accurately uncover masked tokens while preserving the original next-token prediction capability. For example, the draft model can be trained to decode both the next token right after i and its following masked tokens. For example, assume the masked tokens are located at i+1, i+2, . . . , i+γ−1, the training loss can be based on Equation 9, below.

$${ℒ}^{( S 3 D )} = \frac{1}{\vert D \vert} {\sum }_{j ∈ D} - log {q ( {t}_{\leq j} )}_{{t}_{j + 1}} \qquad [ Equation 9 ]$$

In Equation 9, decoding set D={i, i+1, . . . , i+γ−1}. Also, during training, the skipped layers can be frozen to preserve the target model distribution. According to an embodiment, instead of predicting next tokens sequentially, masked tokens can be assigned randomly so that training samples can be processed in one batch, utilizing the parallelism of the transformer. For example, the lower and upper layers of the decoder can be fine-tuned during training while the middle skipped layers can be frozen.

According to an embodiment, the AI device 100 implementing the S3D model can provide improved cost-effectiveness while also exhibiting high training efficiency and maintaining the effectiveness of the original target model.

Also, the AI device 100 implementing the S3D model can better accelerate inference in large language models while minimizing computational and memory overhead, while avoiding extensive model retraining or modification, and maintaining high output quality, even in resource-constrained environments.

Various experiments were carried out against related art models to evaluate the results, in which two different versions of the S3D model were used (e.g., S3D, S3D Phi-3, fp16). For example, Table I shows cost-effectiveness comparisons on A10G GPU considering peak VRAM costs. All models are 8-bit quantized and are based on the 7B LLaMA-v2 target model except mentioned otherwise in parentheses. The largest 3 numbers in each column are highlighted in italics or bold. “Peak” denotes the peak VRAM usage in GiB. The overall (averaged) results count for both M speed and the relative effectiveness metrics compared to the baseline.

As shown in Table I below, the AI model according to embodiments, either outperforms other methods or at least performs comparably, while also having a much smaller size and fewer parameters or reduced memory cost.

TABLE I

| | MT-Bench | | | | Human-Eval | | | | CNN-Daily | | | | | Overall | |
|---|---|---|---|---|---|---|---|---|---|---|---|---|---|---|---|
| Model\Metric | Peak ↓ | Tok/s | M | Score | Peak ↓ | Tok/s | M | Acc. % | Peak ↓ | Tok/s | M | R-1 | R-L | M | Eff. |
| Baseline | 8.53 | 7.02 | 1.00 | 7.05 | 8.43 | 7.02 | 1.00 | 6.71 | 8.96 | 6.53 | 1.00 | 0.19 | 0.13 | 1.00 | 1.00 |
| Self-Spec. | 7.77 | 5.00 | 0.78 | 7.08 | 7.46 | 4.89 | 0.79 | 6.10 | 8.09 | 5.01 | 0.85 | 0.19 | 0.14 | 0.81 | 0.97 |
| Medusa (Viscous) | 9.09 | 9.27 | 1.24 | 4.98 | 8.94 | 10.69 | 1.44 | 7.93 | 9.36 | 7.62 | 1.12 | 0.24 | 0.14 | 1.26 | 1.03 |
| EAGLE | 9.58 | 13.03 | 1.65 | 6.98 | 9.45 | 15.22 | 1.93 | 5.49 | 9.86 | 12.43 | 1.73 | 0.19 | 0.13 | 1.77 | 0.94 |
| MCSD | 7.76 | 7.72 | 1.21 | 6.79 | 7.40 | 7.77 | 1.26 | 9.76 | 8.10 | 6.74 | 1.14 | 0.20 | 0.14 | 1.21 | 1.16 |
| Sequoia | 8.44 | 8.64 | 1.24 | 6.46 | 8.35 | 9.01 | 1.30 | 3.05 | 8.57 | 7.99 | 1.28 | 0.18 | 0.12 | 1.27 | 0.77 |
| Ouroboros | 7.95 | 5.47 | 0.84 | 7.08 | 7.61 | 5.83 | 0.92 | 8.54 | 8.30 | 4.91 | 0.81 | 0.18 | 0.13 | 0.86 | 1.09 |
| CLLM | 7.51 | 11.75 | 1.90 | 5.31 | 7.37 | 16.29 | 2.66 | 3.66 | 7.53 | 8.06 | 1.47 | 0.20 | 0.14 | 2.01 | 0.79 |
| Ours | | | | | | | | | | | | | | | |
| S3D | 7.79 | 12.39 | 1.93 | 5.68 | 7.60 | 13.85 | 2.19 | 6.71 | 8.80 | 9.58 | 1.49 | 0.28 | 0.19 | 1.87 | 1.09 |
| S3D (Pbi-3, fp16) | 8.14 | 25.31 | 3.78 | 7.04 | 7.92 | 28.13 | 4.27 | 20.12 | 8.87 | 17.35 | 2.69 | 0.25 | 0.18 | 3.58 | 1.77 |

As shown above, models producing high speedups are not necessarily the most cost-effective, as seen in the case of Medusa and EAGLE, where the cost of extra draft module(s) must be considered. Table I shows that the S3D models, according to embodiments, generally maintain baseline effectiveness and achieve the highest overall effectiveness among systems using target model training. Further, the S3D model can preserve effectiveness scores more robustly while achieving the optimal speed-memory ratios.

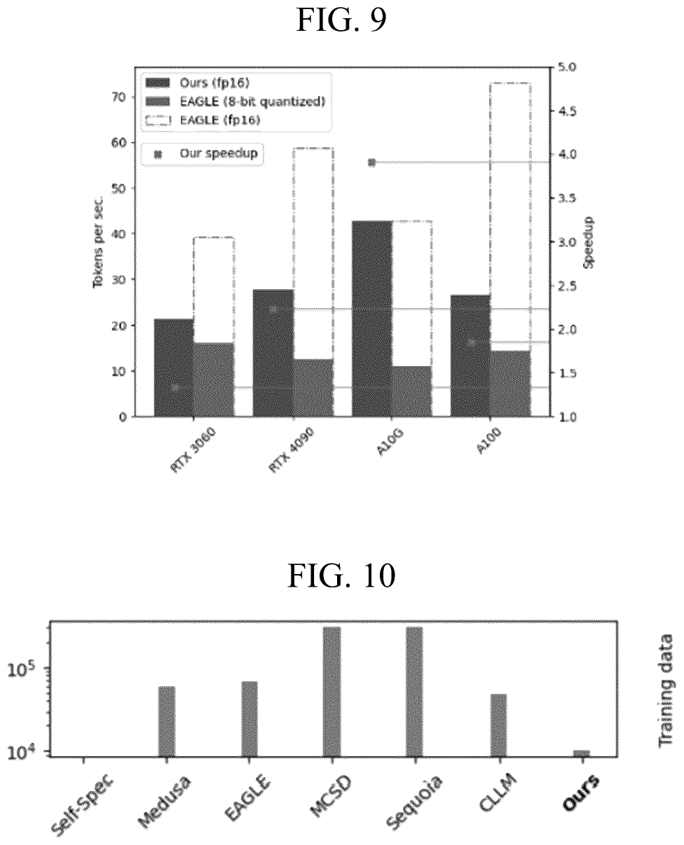

In addition, as shown in FIG. 9, a speed comparison between S3D and other models is shown, in which S3D has a greater speedup than EAGLE (8-bit), and in some situations it is twice as fast or more (e.g., RTX 4090 and A10G).

Further, FIG. 10 illustrates training efficiencies of S3D (e.g., ours) when compared to other related art models. As discussed above, due to the minimal number of parameters subject to fine-tuning in the S3D AI model, the training or adaptation process can be performed with substantially less training data compared to full fine-tuning or training of auxiliary models. This reduction in data requirements leads to high training efficiency and reduced computational overhead for model adaptation. For example, in some embodiments, the S3D AI model can be effectively fine-tuned using a comparatively small dataset, such as approximately ten thousand to twenty thousand rows of training data, in order to achieve desired performance characteristics for speculative decoding.

According to an embodiment, the AI device 100 can be configured to accelerate the inference of large AI models. For example, the 3D methodology, according to embodiments disclosed herein, offers substantial advantages in terms of memory efficiency and operational cost. By utilizing existing components of the original target model for both draft generation and verification stages, the S3D approach obviates the need for separate draft models or the introduction of numerous new parameters or specialized architectural heads. This inherently minimizes additional Video Random Access Memory (VRAM) requirements, rendering the system particularly advantageous for deployment in memory-constrained environments, including but not limited to low-memory Graphics Processing Units (GPUs) and resource-limited edge devices such as televisions or portable computing devices. The reduced memory footprint contributes to overall system cost-effectiveness.

In addition, according to embodiments, the S3D model exhibits high training efficiency and requires minimal modifications to the existing model architecture. The fine-tuning process can be highly targeted, potentially involving only a select subset of layers designated for drafting purposes. This focused adaptation requires orders of magnitude less training data compared to methodologies that necessitate training entirely separate draft models or substantially augmenting the original model with additional trainable components. Such efficient and minimal training procedures further underscore the cost-effectiveness and ease of implementation of the S3D approach.

Further, the S3D model can achieve significant speedups in inference, demonstrating an optimal balance between computational performance and memory utilization. For example, these efficiency gains are realized while preserving the output distribution characteristics of the original target model. For instance, under greedy decoding conditions, outputs can be identical or substantially similar to those of the original model, and for sampling-based generation, the S3D system can sample from the same underlying distribution. This fidelity is further maintained by avoiding potential reductions in acceptance rates or output quality that can be associated with certain alternative sampling strategies, such as those involving sampling without replacement.

According to embodiments, the robustness of the S3D approach is demonstrated by its commendable performance across a diverse range of natural language processing tasks, including but not limited to text summarization, code generation, and multi-turn conversational applications. Also, the S3D model can be compatible with and can be effectively applied to LLMs that have already undergone prior fine-tuning or training for specific tasks. This addresses a common challenge encountered with other decoding techniques, thereby broadening the applicability and utility of the S3D approach to a wider array of pre-trained and specialized foundation models.

The AI device 100 can be used in various types of different situations. For example, the S3D method can be integrated into a wide array of Generative Artificial Intelligence applications that leverage Large Language Models (LLMs). A particularly advantageous area of application is in environments where LLMs are deployed on resource-constrained edge devices. The enhanced efficiency and reduced memory overhead provided by S3D can facilitate the execution of powerful LLM functionalities directly on such devices, which traditionally lack the computational capacity for operating large-scale models effectively.

Further, examples of edge device applications benefiting from the S3D method can include, but are not limited to, Smart Televisions (TVs), in which S3D can enable the operation of fast and responsive chatbots or voice assistants directly on the TV without sole reliance on cloud processing. Similarly, laptop computers can utilize S3D to perform various LLM processing tasks locally, enhancing privacy and reducing latency. Furthermore, robotic systems, acting as sophisticated edge devices, can leverage S3D for improved on-board natural language understanding and interaction capabilities, leading to more autonomous and responsive robotic behavior.

The improvements in inference speed and efficiency offered by S3D are beneficial to a broad spectrum of applications. For instance, chatbots and virtual assistants, whether deployed on edge devices or server-based infrastructure, to provide faster and more fluid conversational experiences. Real-time translation services can achieve lower latency, making interactions more seamless. Content generation processes, such as drafting documents or creating narrative elements, can be significantly expedited. In gaming and other interactive applications, S3D can enhance the responsiveness and perceived intelligence of non-player characters (NPCs) or other AI-driven elements.

In addition, the utility of the S3D approach is not limited to resource-constrained environments. According to embodiment, the methodology can also be applied to improve the decoding speed and operational efficiency of larger, potentially proprietary or in-house, LLMs. By enabling targeted fine-tuning of specific layers within these extensive models, S3D can reduce computational overhead and accelerate inference even for models deployed in well-resourced data center environments, thereby optimizing overall system performance and reducing operational costs.

According to one or more embodiments of the present disclosure, the AI device 100 can solve one or more technological problems in the existing technology, such as providing an improved method that can accelerate inference in large language models while minimizing computational and memory overhead, avoiding extensive model retraining or modification, and maintaining high output quality, especially in resource-constrained environments.

Also, according to an embodiment, the AI device 100 configured with the S3D AI model can be used in a mobile terminal, a smart TV, a home appliance, a robot, an infotainment system in a vehicle, etc.

Further, according to an embodiment, the AI device 100 including the S3D model can implement a method that can provide a more efficient, accurate and privacy-conscious solution.

For example, the AI device can be applied in a wide range of interactive applications including a digital assistant, a question and answering system, and a home robot. For example, according to an embodiment, the home robot can determine the user's intent or emotional state and based on this information, the robot can perform a more relevant helping or caring action, or provide a better answer or information that more accurately addresses the user's needs.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, an input sequence of tokens;
appending, by the processor, one or more mask tokens to the input sequence of tokens to generate a modified input token sequence;
inputting, by the processor, the modified input token sequence to a draft AI model, the draft AI model including a subset of layers of a target AI model;
generating, by the draft AI model, one or more draft tokens based on the modified input token sequence;
verifying the one or more draft tokens, by the target AI model, to generate at least one accepted token; and
generating an updated sequence of tokens by appending the at least one accepted token to the input sequence of tokens and outputting the updated sequence of tokens.

2. The method of claim 1, wherein the target AI model includes a decoder-based transformer, and
wherein the draft AI model includes at least a lowermost layer of the decoder-based transformer in the target AI model and an uppermost layer of the decoder-based transformer in the target AI model, and the draft AI model excludes one or more middle layers of decoder-based transformer in the target AI model.

3. The method of claim 2, further comprising:
fine-tuning the subset of layers of the target AI model that form the draft AI model,
wherein the fine-tuning is performed while parameters of the one or more middle layers of the decoder-based transformer excluded from the draft AI model remain frozen.

4. The method of claim 1, wherein the generating the one or more draft tokens includes concurrently generating a plurality of candidate draft tokens for one or more token positions corresponding to the one or more mask tokens.

5. The method of claim 4, wherein the appending one or more mask tokens includes appending a plurality of mask tokens, and
wherein the generating the plurality of candidate draft tokens further includes:
generating a first set of candidate tokens for a first mask token position of the plurality of mask tokens;
generating a second set of candidate tokens for a second mask token position of the plurality of mask tokens; and
forming a tree structure of candidate draft sequences by combinatorially combining candidate tokens from the first set with candidate tokens from the second set, wherein the plurality of candidate draft tokens include tokens from the tree structure.

6. The method of claim 5, wherein the verifying the one or more draft tokens includes verifying the tree structure of the candidate draft sequences using the target AI model in a single forward pass based on a tree attention mechanism.

7. The method of claim 1, wherein the verifying the one or more draft tokens includes:
determining a first probability for a draft token generated by the draft AI model;
determining a second probability for the draft token from the target AI model; and
accepting the draft token based at least in part on a comparison of the first probability and the second probability or dividing the second probability by the first probability.

8. The method of claim 1, further comprising:
in response to a determination during the verifying the one or more draft tokens resulting in at least one draft token being rejected, generating a replacement token for the at least one draft token being rejected using the target AI model operating in a full autoregressive mode.

9. The method of claim 1, wherein the draft AI model consists exclusively of the subset of layers of the target AI model without requiring additional trainable parameters separate from the target AI model for its operation.

10. The method of claim 1, wherein the updated sequence of tokens maintains a generative distribution substantially identical to an output sequence that would be generated by the target AI model operating in a purely autoregressive mode without intervention from the draft AI model.

11. An artificial intelligence (AI) device, comprising:
a memory configured to store a target AI model; and
a controller configured to:
receive an input sequence of tokens,
append one or more mask tokens to the input sequence of tokens to generate a modified input token sequence,
input the modified input token sequence to a draft AI model, the draft AI model including a subset of layers of the target AI model,
generate one or more draft tokens based on the modified input token sequence,
verify the one or more draft tokens, by the target AI model, to generate at least one accepted token, and
generate an updated sequence of tokens by appending the at least one accepted token to the input sequence of tokens and output the updated sequence of tokens.

12. The AI device of claim 11, wherein the target AI model includes a decoder-based transformer, and
wherein the draft AI model includes at least a lowermost layer of the decoder-based transformer in the target AI model and an uppermost layer of the decoder-based transformer in the target AI model, and the draft AI model excludes one or more middle layers of decoder-based transformer in the target AI model.

13. The AI device of claim 12, wherein the controller is further configured to:
fine-tune the subset of layers of the target AI model that form the draft AI model while parameters of the one or more middle layers of the decoder-based transformer excluded from the draft AI model remain frozen.

14. The AI device of claim 11, wherein the controller is further configured to:
concurrently generate a plurality of candidate draft tokens for one or more token positions corresponding to the one or more mask tokens.

15. The AI device of claim 14, wherein the controller is further configured to:
append a plurality of mask tokens to the input sequence of tokens to generate the modified input token sequence,
generate a first set of candidate tokens for a first mask token position of the plurality of mask tokens,
generate a second set of candidate tokens for a second mask token position of the plurality of mask tokens, and
form a tree structure of candidate draft sequences by combinatorially combining candidate tokens from the first set with candidate tokens from the second set, wherein the plurality of candidate draft tokens include tokens from the tree structure.

16. The AI device of claim 15, wherein the controller is further configured to:
verify the one or more draft tokens based on verifying the tree structure of the candidate draft sequences using the target AI model in a single forward pass based on a tree attention mechanism.

17. The AI device of claim 11, wherein the controller is further configured to:
determine a first probability for a draft token generated by the draft AI model,
determine a second probability for the draft token from the target AI model, and
accept the draft token based at least in part on a comparison of the first probability and the second probability or dividing the second probability by the first probability.

18. The AI device of claim 11, wherein the controller is further configured to:
in response to a determination of the one or more draft tokens resulting in at least one draft token being rejected, generate a replacement token for the at least one draft token being rejected using the target AI model operating in a full autoregressive mode.

19. The AI device of claim 11, wherein the updated sequence of tokens maintains a generative distribution substantially identical to an output sequence that would be generated by the target AI model operating in a purely autoregressive mode without intervention from the draft AI model.

20. A non-transitory computer readable medium storing computer-executable instructions that when executed by a processor, cause the processor to perform the operations of:
receiving an input sequence of tokens;
appending one or more mask tokens to the input sequence of tokens to generate a modified input token sequence;
inputting the modified input token sequence to a draft artificial intelligence (AI) model, the draft AI model including a subset of layers of a target AI model;
generating, by the draft AI model, one or more draft tokens based on the modified input token sequence;
verifying the one or more draft tokens, by the target AI model, to generate at least one accepted token; and
generating an updated sequence of tokens by appending the at least one accepted token to the input sequence of tokens and outputting the updated sequence of tokens.
